(19) United States
(12) Patent Application Publication
(10) Pub. No.: US 2026/0105396 A1
(43) Pub. Date: Apr. 16, 2026

(54) INFORMATION PROCESSING APPARATUS, INFORMATION PROCESSING METHOD, AND NON-TRANSITORY COMPUTER-READABLE STORAGE MEDIUM

(71) Applicant: NEC Corporation, Tokyo (JP)

(72) Inventor: Shohei MITANI, Tokyo (JP)

(73) Assignee: NEC Corporation, Tokyo (JP)

(21) Appl. No.: 19/344,944

(22) Filed: Sep. 30, 2025

(30) Foreign Application Priority Data
Oct. 10, 2024 (JP) 2024-178479

(51) Int. Cl. G06Q 10/0635; G06Q 10/10

(52) U.S. Cl. CPC G06Q 10/0635; G06Q 10/103

(57) ABSTRACT

An information processing apparatus includes a risk index calculation means and a risk analysis means. The risk index calculation means calculates a risk index value related to at least one or more risk factors accompanying a design result prior to present time by using the design result at least prior to the present time related to a plurality of design tasks constituting a design flow of a system, requirements input in natural language for the design of the system, and constraint conditions. The risk analysis means analyzes the risk factors based on the calculated risk index value, and presents an analysis result of the risk factors to a user.

### INCORPORATION BY REFERENCE

This application is based upon and claims the benefit of priority from Japanese Patent Application No. 2024-178479, filed on October 10, 2024, the disclosure of which is incorporated herein in its entirety by reference.

### TECHNICAL FIELD

The present disclosure relates to an information processing apparatus, an information processing method, and a non-transitory computer-readable storage medium.

### BACKGROUND ART

In a system development project, risk management plays an important role in ensuring the success of the project.

As a method for project risk evaluation, there is a case where a method of aggregating evaluation values of people based on development documents or the like is used (see, for example, Patent Literature 1 (JP2022-180289 A)).

In addition, in the field of text quality analysis, a method has been proposed in which the quality of documents or the like is evaluated by using natural language processing technology to learn from good examples and bad examples.

However, development tasks for complex systems have hierarchical dependencies. Therefore, if there are defects in deliverables at each stage, quality risks such as rework, missed deadlines, or failure to meet performance requirements may arise. For this reason, appropriate quality evaluation means are required at each stage of the development process.

### SUMMARY

It is a main object of the present disclosure to provide an information processing apparatus, an information processing method, and a non-transitory computer-readable storage medium that contribute to realizing appropriate quality evaluation at each stage of the development process.

According to a first aspect of the present disclosure, there is provided an information processing apparatus including: a risk index calculation means that calculates a risk index value related to at least one or more risk factors accompanying a design result prior to present time by using the design result at least prior to the present time related to a plurality of design tasks constituting a design flow of a system, requirements input in natural language for the design of the system, and constraint conditions; and a risk analysis means that analyzes the risk factors based on the calculated risk index value, and presents an analysis result of the risk factors to a user.

According to a second aspect of the present disclosure, there is provided an information processing method including: calculating a risk index value related to at least one or more risk factors accompanying a design result prior to present time by using the design result at least prior to the present time related to a plurality of design tasks constituting a design flow of a system, requirements input in natural language for the design of the system, and constraint conditions; analyzing the risk factors based on the calculated risk index value; and presenting an analysis result of the risk factors to a user.

According to a third aspect of the present disclosure, there is provided a non-transitory computer-readable storage medium storing a program causing a computer mounted on an information processing apparatus to perform processing for: calculating a risk index value related to at least one or more risk factors accompanying a design result prior to present time by using the design result at least prior to the present time related to a plurality of design tasks constituting a design flow of a system, requirements input in natural language for the design of the system, and constraint conditions; analyzing the risk factors based on the calculated risk index value; and presenting an analysis result of the risk factors to a user.

### BRIEF DESCRIPTION OF THE DRAWINGS

Exemplary features and advantages of the present disclosure will become apparent from the following detailed description when taken with the accompanying drawings in which:

FIG. 1 is a diagram illustrating an outline of an example embodiment;

FIG. 2 is a flowchart illustrating an operation of an example embodiment;

FIG. 3 is a diagram illustrating an example of a schematic configuration of an information processing system according to an embodiment of the present disclosure;

FIG. 4 is a diagram for explaining an operation of the information processing system according to the embodiment of the present disclosure;

FIG. 5 is a diagram illustrating an example of a processing configuration of the information processing apparatus according to the embodiment of the present disclosure;

FIG. 6 is a flowchart illustrating an example of an operation of a risk index calculation unit according to the embodiment of the present disclosure;

FIG. 7 is a diagram illustrating an example of a requirement information table according to the embodiment of the present disclosure;

FIG. 8 is a diagram illustrating an example of a constraint information table according to the embodiment of the present disclosure;

FIG. 9 is a diagram illustrating an example of a design result table of a preceding design task according to the embodiment of the present disclosure;

FIG. 10 is a diagram illustrating an example of a constraint condition table of a current design task according to the embodiment of the present disclosure;

FIG. 11 is a diagram for explaining the operation of a risk index calculation unit according to the embodiment of the present disclosure;

FIG. 12 is a flowchart illustrating an example of an operation of a risk analysis unit according to the embodiment of the present disclosure;

FIG. 13 is a diagram illustrating an example of information output by the risk analysis unit according to the embodiment of the present disclosure;

FIG. 14 is a flowchart illustrating an example of an operation of the information processing apparatus according to the embodiment of the present disclosure;

FIG. 15 is a diagram illustrating an example of a processing configuration of the information processing apparatus according to the embodiment of the present disclosure;

FIG. 16 is a diagram illustrating an example of a display of a terminal according to the embodiment of the present disclosure; and

FIG. 17 is a diagram illustrating an example of a hardware configuration of the information processing apparatus according to the embodiment of the present disclosure.

### EXAMPLE EMBODIMENT

First, an outline of an example embodiment will be described. In the following outline, various components are denoted by reference characters for the sake of convenience. That is, the following reference characters are used as examples to facilitate the understanding of the present disclosure. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

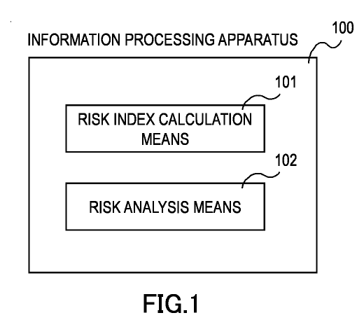

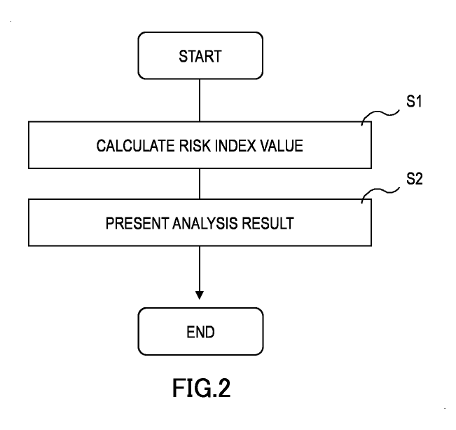

An information processing apparatus 100 according to an example embodiment includes a risk index calculation means 101 and a risk analysis means 102 (see FIG. 1). The risk index calculation means 101 calculates a risk index value related to at least one or more risk factors accompanying a design result prior to present time by using the design result at least prior to the present time related to a plurality of design tasks constituting a design flow of a system, requirements input in natural language for the design of the system, and constraint conditions (step S1 in FIG. 2). The risk analysis means 102 analyzes the risk factors based on the calculated risk index value, and presents an analysis result of the risk factors to a user (step S2).

The information processing apparatus 100 calculates a risk index value obtained by quantifying the risk factors accompanying the design results at each design stage of a development process. The information processing apparatus 100 analyzes risks by using the calculated risk index value, and presents the obtained analysis results to a user. As a result, appropriate quality evaluation is realized at each stage of the development process.

Hereinafter, specific example embodiments will be described in more detail with reference to drawings.

### First Example Embodiment

A first example embodiment will be described in more detail with reference to drawings.

### Configuration and Schematic Operation of System

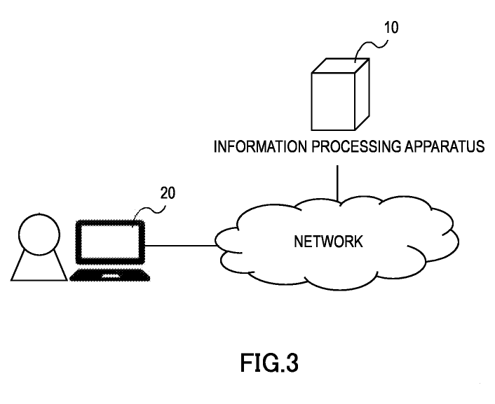

As shown in FIG. 3, an information processing system according to the first example embodiment includes an information processing apparatus 10 and a terminal 20.

The information processing apparatus 10 is an information processing apparatus for supporting system design by a user. For example, the information processing apparatus 10 is a server installed on a network (on a cloud).

The user operates the terminal 20 to access the information processing apparatus 10. The user inputs various information to the information processing apparatus 10 or acquires various information from the information processing apparatus 10.

The information processing apparatus 10 performs risk analysis and countermeasure proposal in a system design process.

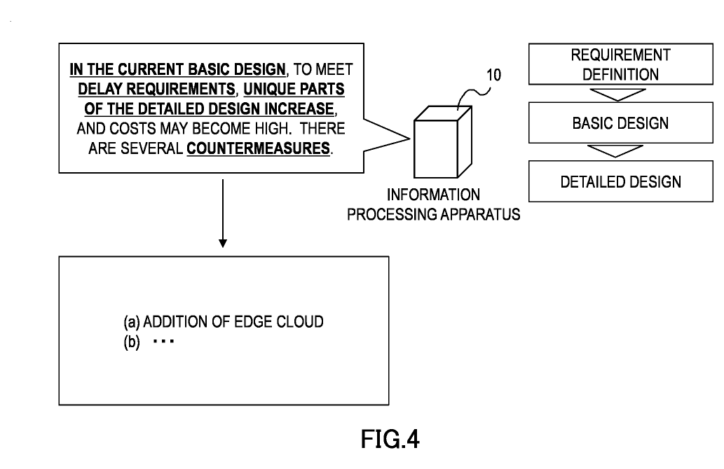

For example, as shown in the balloon at the top of FIG. 4, the information processing apparatus 10 presents a problem (risk) in the current basic design phase to a user. For example, as shown in FIG. 4, the information processing apparatus 10 presents to the user that in the current basic design, in order to satisfy a delay requirement, the design target portion (original design amount) in the detailed design increases and costs may also increase.

It should be noted that on the right side of FIG. 4, each stage of the design process (requirement definition, basic design, detailed design) is shown, and FIG. 4 illustrates an example of a problem (risk) in the transition period from the basic design to the detailed design.

In a frame at the bottom of FIG. 4, a countermeasure plan for the above problem is shown. Specifically, the information processing apparatus 10 presents "(a) addition of an edge cloud" as a countermeasure plan for the above problem to the user. That is, the information processing apparatus 10 presents "(a) addition of an edge cloud" as one solution for satisfying the delay requirement.

It should be noted that "(b) ... " described in the frame at the bottom of FIG. 4 suggests that other countermeasure plans exist. It should be noted that in FIG. 4, a detailed description of the other countermeasure plans is omitted.

As described above, the information processing apparatus 10 according to the embodiment of the present disclosure analyzes risks in each stage of the system design process and proposes appropriate countermeasures to the user. For example, the information processing apparatus 10 identifies a problem (in the above example, risks of the delay requirement and cost increase) that occurred in the basic design phase. For example, the information processing apparatus 10 identifies a problem (in the above example, risks of the delay requirement and cost increase) that occurred in the basic design phase.

As a result, designers and decision-makers involved in system development can recognize risks at an early stage and take appropriate action.

The information processing apparatus 10 plays a role in supporting risk management throughout the design process and increasing the probability of project success by automatically performing such analysis and proposals.

Next, details of the information processing apparatus 10 according to the first embodiment will be described.

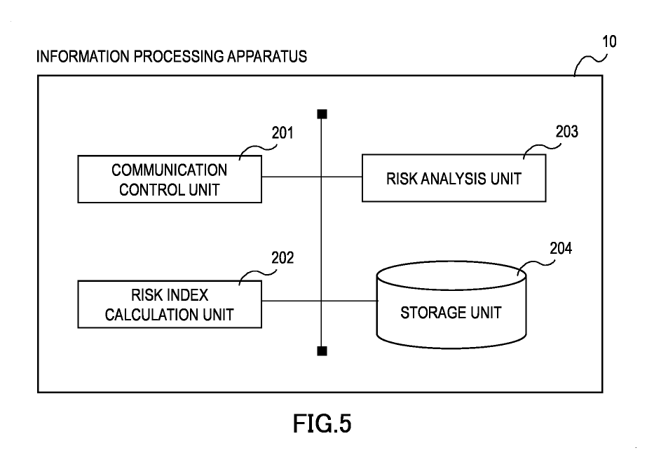

FIG. 5 is a diagram illustrating an example of a processing configuration (processing module) of the information processing apparatus 10 according to the embodiment of the present disclosure. Referring to FIG. 5, the information processing apparatus 10 includes a communication control unit 201, a risk index calculation unit 202, a risk analysis unit 203, and a storage unit 204.

The communication control unit 201 is means for controlling communication with other apparatuses. For example, the communication control unit 201 receives data (packets) from the terminal 20. In addition, the communication control unit 201 transmits data to the terminal 20. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses.

The risk index calculation unit 202 is means for quantifying issues (risks) assumed at each stage of the design process (requirement definition, basic design, detailed design). The risk index calculation unit 202 calculates, as a risk index value, the magnitude of the impact that various events (events that hinder the success of the project) in each design process have on the system and the system design. The risk index calculation unit 202 outputs the calculated risk index value.

The risk index calculation unit 202 acquires, as input data, design information, requirement information, constraint information, design results of a preceding design task, and constraint conditions of a current design task, or the like, related to the system. For example, the risk index calculation unit 202 acquires design information, requirement information, constraint information, design results of a preceding design task, constraint conditions of a current design task, or the like, specified by a user via the terminal 20.

The design information is specific design information at each stage (design process). For example, information described in a requirement definition document, a basic design document, a detailed design document, or the like, falls under the category of the design information. It should be noted that descriptions of other information (requirement information, constraint information, design results of a preceding design task, and constraint conditions of a current design task) will be given below.

The risk index calculation unit 202 performs predetermined analysis on the acquired input data to calculate, as a risk index value, the degree of influence that various events have on the system or the like, and outputs the calculated risk index value to the risk analysis unit 203. Furthermore, the risk index calculation unit 202 outputs the input data used for calculating the risk index value to the risk analysis unit 203 together with the risk index value.

The risk analysis unit 203 is means for analyzing issues (risks) in each design task (design process).

The risk analysis unit 203 acquires a risk index value from the risk index calculation unit 202. The risk analysis unit 203 performs threshold processing on the acquired risk index value and determines whether or not the risk index value exceeds a preset threshold.

In a case where the risk index value exceeds the threshold, the risk analysis unit 203 analyzes the reason for the increase in risk using a language model.

Furthermore, the risk analysis unit 203 searches for countermeasures to reduce the risk. Specifically, the risk analysis unit 203 virtually changes a part of the design (for example, sensor selection or communication protocol) and simulates the change in the risk index value with respect to the change. More specifically, the risk analysis unit 203 passes each virtually changed design (design information) to the risk index calculation unit 202 and instructs the calculation of the risk index.

Through these processes, the risk analysis unit 203 finally outputs the type of risk, the risk index value, the reason for the increase in risk, and a recommended countermeasure.

### Detailed Description of Data Used by the Risk Index Calculation Unit 202 and Detailed Description of Operation

The operation of the risk index calculation unit 202 will be described in further detail. The risk index calculation unit 202 performs the following processing after acquiring input data.

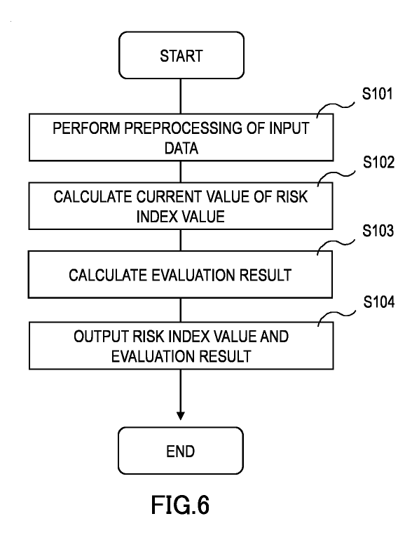

FIG. 6 is a flowchart illustrating an example of the operation of the risk index calculation unit 202 according to the example embodiment disclosed in the present application. With reference to FIG. 6, the operation of the risk index calculation unit 202 will be described.

First, the risk index calculation unit 202 performs preprocessing of the input data (step S101).

Specifically, the risk index calculation unit 202 extracts risk factors (information related to risks) based on requirement information, constraint information, design results of a preceding design task, and constraint conditions of a current design task, or the like. For example, the risk index calculation unit 202 extracts information related to price, the amount of original design, communication bandwidth, reliability of a parts manufacturer, or the like, as risk factors.

The risk index calculation unit 202 acquires, for example, table information describing the above-mentioned requirement information, constraint information, design results of a preceding design task, and constraint conditions of a current design task, or the like, from an external storage device (database). The risk index calculation unit 202 extracts the above-mentioned risk factors using the acquired table information.

Here, with reference to the drawings, each piece of data (table information) used by the risk index calculation unit 202 will be described.

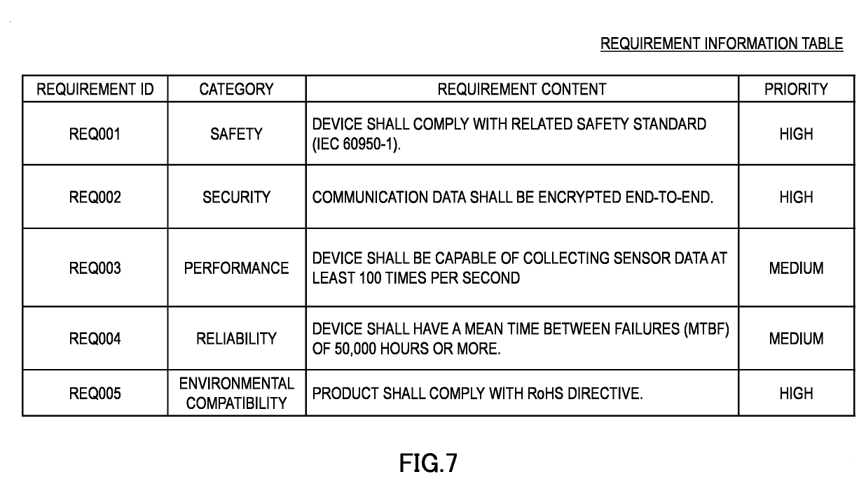

FIGS. 7 to 10 illustrate four main data tables (table information) used as input data for the risk analysis system (information processing system).

The requirement information table shown in FIG. 7 defines the basic requirements that a product (final system) should satisfy. As shown in FIG. 7, the requirement information table is composed of columns for a requirement ID, a category, requirement details, and a priority.

For example, the requirement information of requirement ID "REQ001" indicates a high-priority safety requirement and is treated as particularly important information in the design process. Alternatively, requirement ID "REQ003" defines specific performance targets for a device with a medium priority.

The risk index calculation unit 202 evaluates whether these requirements are satisfied in design information to be evaluated (for example, information described in a requirement definition document, a basic design document, or a detailed design document), and determines the risk level in accordance with the priority (sets a risk index value in accordance with the priority).

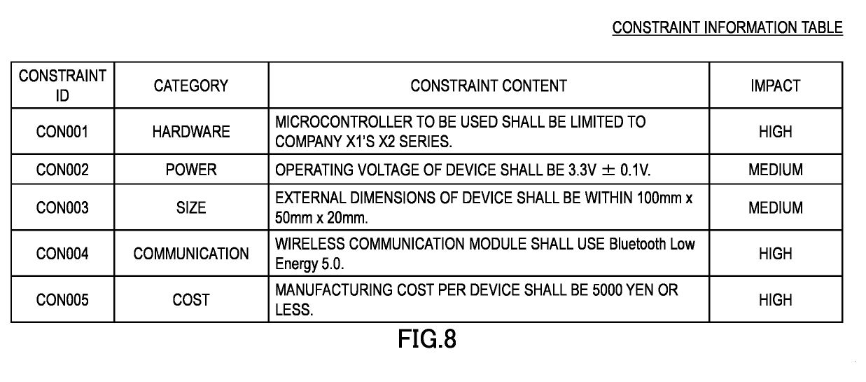

The constraint information table shown in FIG. 8 defines specific restrictions related to design and manufacturing. As shown in FIG. 8, the constraint information table includes columns for a constraint ID, a category, constraint details, and an impact level.

A high-impact constraint, such as constraint ID "CON001", is important information that affects many aspects of the design.

The risk index calculation unit 202 checks whether the constraints described in the constraint information table are complied with in the design information to be evaluated, and assigns a high risk index value in a case where they are violated.

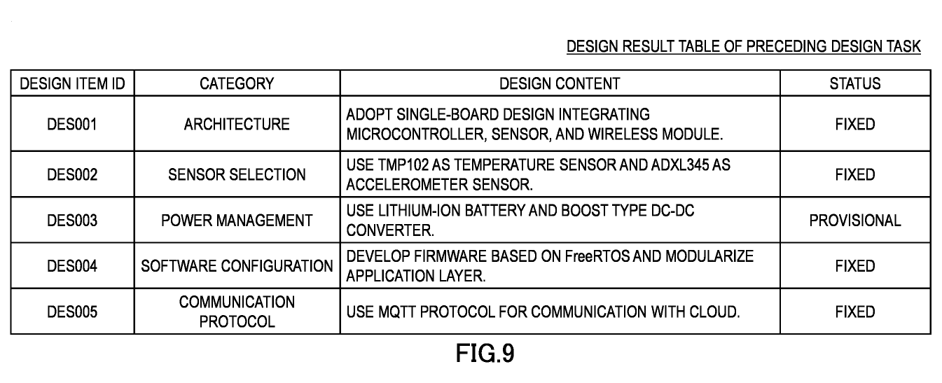

The design result table of a preceding design task shown in FIG. 9 indicates design decisions that have already been made. As shown in FIG. 9, the design result table of the preceding design task is composed of columns for a design item ID, a category, design details, and a status.

The design item ID "DES001" is a design item in a fixed status. Such design items in a fixed status are important information that greatly affect subsequent designs.

The risk index calculation unit 202 verifies (checks) whether or not the design decisions already made contradict the requirement information or the constraint information. It should be noted that with respect to design items in a provisional status, such as design item ID "DES003", the risk index calculation unit 202 takes into account the possibility of risk occurrence at the time of final decision. That is, the risk index calculation unit 202 verifies the design items in the "fixed" status in preference to the design items set to the "provisional" status.

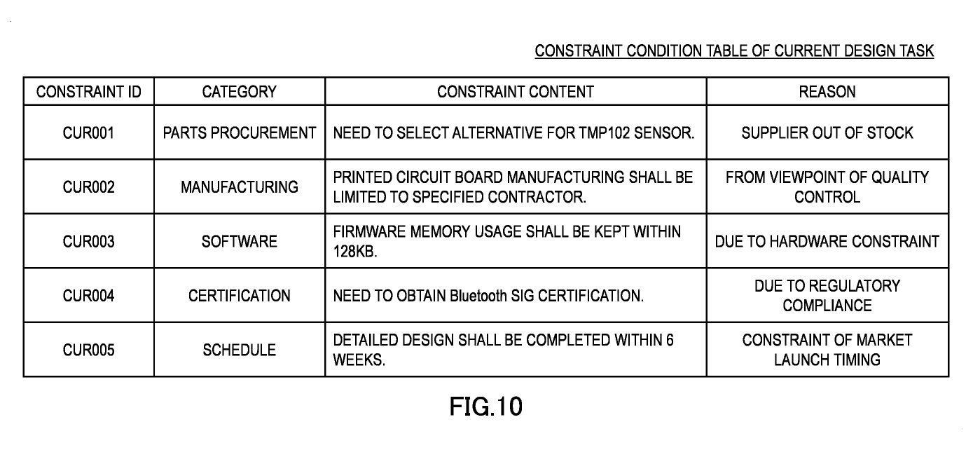

The constraint condition table of the current design task shown in FIG. 10 indicates constraints newly generated in the current design phase. As shown in FIG. 10, the constraint condition table of the current design task is composed of columns for a constraint ID, a category, constraint details, and a reason.

Constraints such as constraint ID "CUR001" may contradict the preceding design results. The risk index calculation unit 202 verifies (checks) whether or not these new constraints contradict the preceding design results or the requirement information, and assigns a high risk index value in a case where a contradiction exists.

A system designer or the like generates the requirement information table and the like described above on the basis of knowledge and experience acquired in past system development, and registers them in the information processing apparatus 10. Alternatively, the designer or the like updates the constraint condition table of the current design task described above at the timing of a change in the system specifications or at the timing of acquisition of information such as the delivery date related to a part to be used from a part manufacturer or the like.

The risk index calculation unit 202 comprehensively analyzes risks in each design stage by using the data described in the four table information above. The risk index calculation unit 202 uses the four table information to extract at least one or more risk factors and calculates a risk index value for the extracted risk factors.

For example, the risk index calculation unit 202 verifies whether or not the performance requirement defined in the requirement information of requirement ID "REQ003" can be realized by the microcontroller specified in the constraint information of constraint ID "CON001". That is, the risk index calculation unit 202 verifies whether or not data collection 100 times per second can be realized by the specific microcontroller designated. In a case where the performance defined in the requirement information is not satisfied, the risk index calculation unit 202 extracts "performance requirement not met risk" as a risk factor.

Alternatively, the risk index calculation unit 202 evaluates (verifies) whether or not the preceding design result of design item ID "DES001" (single board design) can be realized under the current constraint condition of constraint ID "CUR005" (a six-week deadline). In a case where the preceding design (design result) does not satisfy the constraint condition related to the delivery deadline, the risk index calculation unit 202 extracts a "schedule delay risk" as a risk factor.

The risk index calculation unit 202 is able to extract the above-described risk factors using a large language model (LLM; Large Language Model). For example, the risk index calculation unit 202 acquires (extracts) the risk factors by inputting into the LLM a prompt such as "Please extract the risk factors that could be risks in system development by using the design information, the requirement information, the constraint information, the design result of the preceding design task, and the current design task constraint condition table."

Next, the risk index calculation unit 202 calculates the current value (raw data of the risk index value) of each risk factor based on the extracted risk factors and the design information (step S102 of FIG. 6). At that time, the risk index calculation unit 202 uses a predefined evaluation function.

As a method of constructing the evaluation function, for example, a design using a predetermined rule may be adopted. For example, the risk index calculation unit 202 calculates the amount of proprietary design using the design information, with respect to the amount of proprietary design. The risk index calculation unit 202 calculates the ratio of the calculated proprietary design amount to the total design amount and normalizes the ratio, for example, to a range from 0 to 10.

The risk index calculation unit 202 calculates an evaluation result for each risk factor (step S103). Specifically, the risk index calculation unit 202 compares the current value of each calculated risk factor with a predefined threshold. The threshold is set based on past project performance, industry standards, or the like, and serves as a criterion for determining the risk level.

In a case where the current value of a risk factor is equal to or greater than the threshold, the risk index calculation unit 202 sets the evaluation result of the risk factor to "risk present". In a case where the current value of a risk factor is less than the threshold, the risk index calculation unit 202 sets the evaluation result of the risk factor to "no risk".

Here, the risk index calculation unit 202 may perform additional analysis using an external tool. The additional analysis includes configuration simulation, component vulnerability checks, static analysis of source code, and the like. The output results of these external tools may also be incorporated into the calculation of the risk index value.

It should be noted that, in a case where an external tool is used, the risk index calculation unit 202 integrates the evaluation result (current value of the risk index value) of each risk factor with the analysis result of the external tool. Specifically, the risk index calculation unit 202 applies weighting to each element (the evaluation result of the risk factor and the analysis result of the external tool) and calculates a weighted average. The weighting coefficients may be adjusted in accordance with the nature and priorities of the project.

The risk index calculation unit 202 normalizes the calculated weighted average value to a range from 0 to 10, for example. The risk index calculation unit 202 outputs the normalized weighted average value as the risk index value. The higher the risk index value is, the higher the overall project risk is indicated.

As described above, the risk index calculation unit 202 can calculate the risk index value using an evaluation function constructed based on predetermined rules.

Alternatively, the risk index calculation unit 202 may use a machine learning model as the above-described evaluation function.

For example, the risk index calculation unit 202 can calculate the risk index value using a machine learning model, particularly a supervised learning model. In this case, past project data is used as training data, and the necessary learning model is obtained by allowing the machine learning model to learn the relationship between the input features and the target variable (the degree of risk that actually occurred).

An advantage of the risk index calculation unit 202 utilizing a machine learning model is that it can capture complex interactions among a large number of variables. In addition, another advantage of the risk index calculation unit 202 utilizing a machine learning model is that it can update the machine learning model whenever new data becomes available, thereby enabling improvement in prediction accuracy.

Furthermore, the risk index calculation unit 202 may use a method such as SHAP (SHapley Additive exPlanations) values to analyze the extent to which each input factor contributes to the risk index value, in order to improve the interpretability of the learning model. By performing an analysis using the SHAP values, the risk index calculation unit 202 can specifically explain the reason why the risk index value increased.

Thus, by utilizing machine learning, the risk index calculation unit 202 can evaluate risks more precisely and flexibly, thereby increasing the probability of project success.

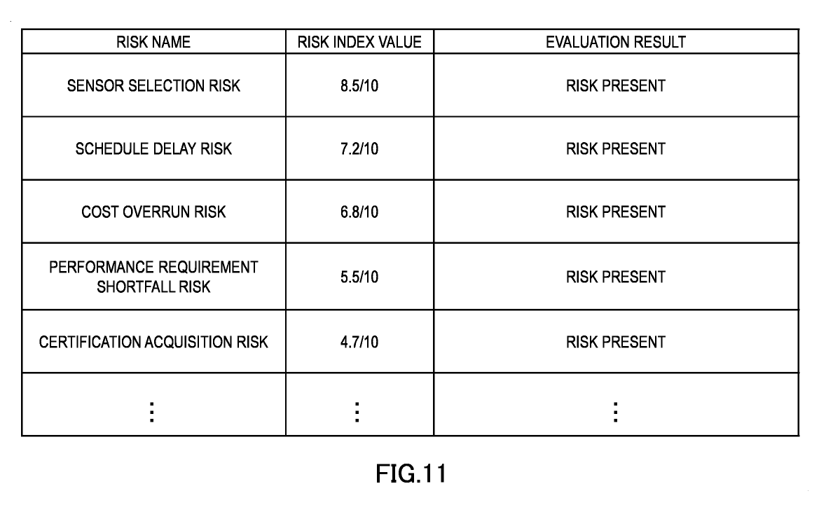

The risk index calculation unit 202 outputs the risk index value for each risk factor and the evaluation result ("risk present", "no risk") to the risk analysis unit 203 (step S104). For example, the risk index calculation unit 202 passes information such as that shown in FIG. 11 to the risk analysis unit 203.

### Details of the risk analysis unit 203

The operation of the risk analysis unit 203 will be described in detail.

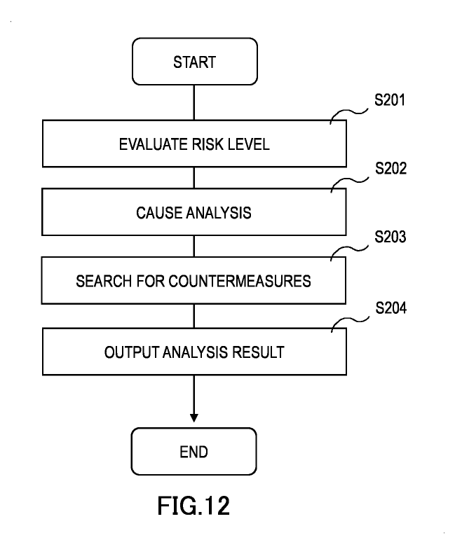

FIG. 12 is a flowchart illustrating an example of an operation of the risk analysis unit 203 according to the example embodiment disclosed in the present application. With reference to FIG. 12, the operation of the risk analysis unit 203 will be described.

The risk analysis unit 203 evaluates the risk level of each risk factor by comparing the risk index value acquired from the risk index calculation unit 202 with a preset threshold (step S201). The threshold can be adjusted in accordance with the nature of the project and the acceptable risk level, and is input in advance into the information processing apparatus 10 by a system administrator or the like.

In a case where the risk index value is less than the threshold, the risk analysis unit 203 does not perform any particular processing.

In a case where the risk index value exceeds the threshold, the risk analysis unit 203 analyzes the specific cause of the increased risk by using a Large Language Model (LLM) (cause analysis; step S202).

The LLM comprehensively interprets the input data (requirement information, constraint information, design result of the preceding design task, constraint condition of the current design task) and the risk index value and evaluation result of each risk factor, and explains the reason for the increased risk in natural language.

More specifically, the risk analysis unit 203 obtains the cause of the increased risk by inputting into the LLM a prompt instructing generation of the reason for the increased risk using the input data, the risk factors, the risk index values, and the evaluation results.

For example, the risk analysis unit 203 obtains the cause of the increased risk (the cause determined to be high risk) by inputting into the LLM a prompt such as "Using the requirement information, the constraint information, the design result of the preceding design task, the constraint condition table of the current design task, the risk index values, and the evaluation results, please explain the reason why the risk index value is high."

It should be noted that the risk analysis unit 203 may refer to task hierarchy information in a case where a specific cause of risk information is analyzed.

The task hierarchy information is information indicating a hierarchical relationship in system development. For example, it is expressed in a flow (order) such as "requirement definition" --> "basic design" --> "detailed design." In each task hierarchy, requirement information, constraint information, design results, and the like are associated with design elements in each task hierarchy. That is, in each of the requirement definition, basic design, and detailed design hierarchies, the requirement information, the constraint information, the design results, and the like are associated with the design elements.

The risk analysis unit 203 may integrally analyze a plurality of pieces of information including the task hierarchy information. More specifically, the risk analysis unit 203 inputs, into the LLM, a prompt instructing generation of a reason for an increase in risk by using the task hierarchy information in addition to the input data, the risk index value, the evaluation result, and the like, thereby acquiring the cause of the increase in risk.

For example, the risk analysis unit 203 generates a specific explanation such as "Since the communication bandwidth is insufficient, it is difficult to realize a function that requires real-time performance."

The risk analysis unit 203 is able to grasp risk factors more deeply by analyzing information in each hierarchy based on the task hierarchy information managed in a graph format, for example.

For example, in a case where the risk index value increases in the detailed design phase, the risk analysis unit 203 refers to the design results and constraint conditions of the basic design phase to generate an analysis result. For example, the risk analysis unit 203 generates an analysis result such as "Since sufficient performance verification was not conducted in the basic design phase, performance problems have been discovered in the detailed design phase, thereby increasing the risk of rework."

Alternatively, in a case where the risk index value increases in the basic design phase, the risk analysis unit 203 refers to the requirement information and the constraint information in the requirement definition phase to generate an analysis result. For example, the risk analysis unit 203 generates an analysis result such as "Since the customer's needs were not sufficiently understood in the requirement definition phase, a significant design change becomes necessary in the basic design phase, thereby increasing the risk of cost overrun."

Upon completion of the cause analysis, the risk analysis unit 203 searches for countermeasure plans for reducing the risk (step S203).

Specifically, the risk analysis unit 203 virtually changes a part of the design information (for example, parts to be used, algorithms, architectures, and the like). For example, the risk analysis unit 203 generates a prompt instructing a change in a part of the design information, and inputs the generated prompt into the LLM to acquire the design information with a part changed.

Thereafter, the risk analysis unit 203 simulates how the change of the design information affects the risk index value.

More specifically, the risk analysis unit 203 passes the virtually changed design information to the risk index calculation unit 202 and instructs the calculation of the risk index. That is, the above simulation is performed by the risk index calculation unit 202, into which the changed design information has been input, re-executing the calculation processing of the risk index value. The risk analysis unit 203 searches for a plurality of countermeasure plans, and evaluates a risk reduction effect due to the change in the design information based on the risk index value recalculated by the risk index calculation unit 202.

For example, the risk analysis unit 203 adopts a change in design information with a low recalculated risk index value as a countermeasure plan for the risk factor.

The risk analysis unit 203 outputs the analysis result (step S204). The risk analysis unit 203 outputs the analysis result to the terminal 20.

For example, the risk analysis unit 203 may finally output the following information in a summarized manner.

1. Type of risk (risk name; for example, cost overrun, delivery delay, quality problem)

2. Risk index value (ranging from 0 to 10)

3. Specific reason for risk increase (natural language description by LLM)

4. At least one or more recommended countermeasure plans (one or a plurality of countermeasure plans)

5. Information indicating how much each countermeasure plan reduces the risk index value (for example, the rate of change of the risk index value before and after the countermeasure, or the like)

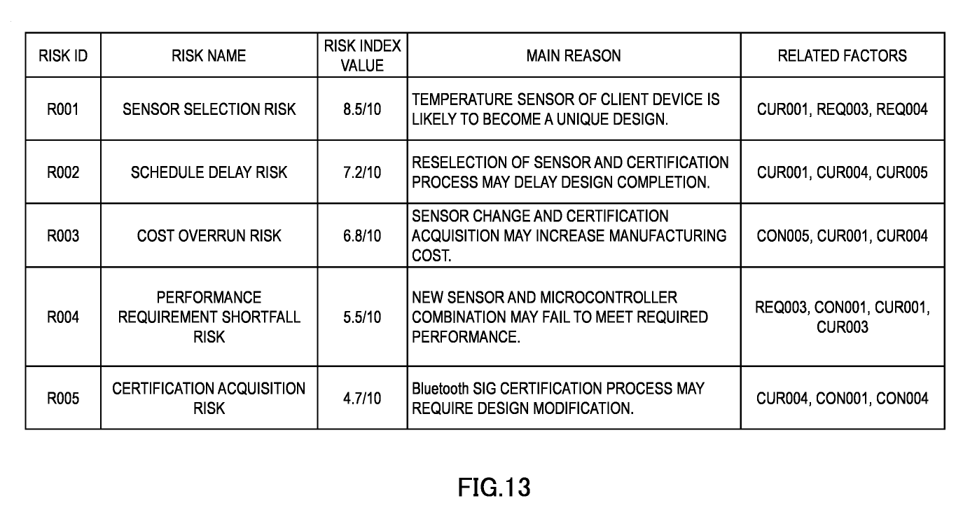

FIG. 13 is a diagram illustrating an example of information output by the risk analysis unit 203. FIG. 13 shows various risks and their evaluations in a specific project or system. As shown in FIG. 13, each risk factor is described with a risk ID, a risk name, a risk index value (an evaluation value with a perfect score of 10), a main reason why the risk factor was determined to be high risk, and related factors.

As described above, the higher the risk index value, the greater the potential impact of the corresponding risk factor on the project. For example, the sensor selection risk of the risk ID "R001" has the highest risk index value of 8.5. The main reason for the high risk index value of the sensor selection risk is that "The temperature sensor of the client device is likely to be of proprietary design."

Furthermore, as factors related to the sensor selection risk, the constraint conditions of constraint ID "CUR001" and the requirements of requirement ID "REQ003" and requirement ID "REQ004" are described. These constraint conditions, requirements, and the like are information for explaining (supplementing) the background and cause of risk occurrence.

The information as shown in FIG. 13 is provided to designers and project managers via the terminal 20 to support decision-making for risk response.

For example, in a case where the risk analysis unit 203 identifies that "the use of expensive parts increases the cost overrun risk," the designer can take measures such as considering less expensive alternative parts or reviewing the design to reduce the number of parts.

The storage unit 204 is means for storing information necessary for the operation of the information processing apparatus 10. For example, the above database is constructed in the storage unit 204.

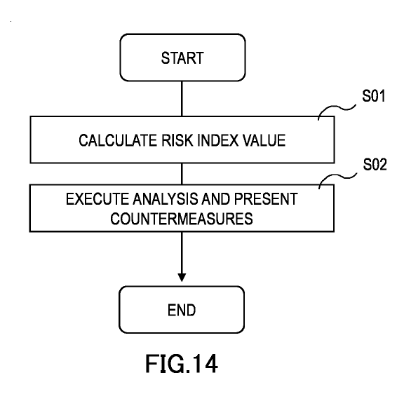

In summary, the operation of the information processing apparatus 10 is as shown in the flowchart of FIG. 14.

First, the information processing apparatus 10 starts a design task of a specific hierarchy by the risk analysis unit 203.

Subsequently, the risk index calculation unit 202 calculates a risk index value based on the design result of the design task and the information (natural language) entered in the current task (step S01).

The risk analysis unit 203 performs a detailed analysis and proposes countermeasure plans as necessary based on the calculated risk index value (execution of analysis and proposal of countermeasure plans; step S02).

### Terminal

A detailed description of the terminal 20 will be omitted. Examples of the terminal 20 include portable terminal devices such as a smartphone, a mobile phone, a game console, or a tablet, and a computer (a personal computer, a laptop computer), or the like. The terminal 20 can be any equipment or device as long as the terminal 20 can accept an operation by a user and can communicate with the information processing apparatus 10.

As described above, the information processing apparatus 10 according to the first example embodiment extracts risk factors in each design stage of the development process and calculates a risk index value obtained by quantifying the risk of the extracted risk factors. The information processing apparatus 10 analyzes the risk using the calculated risk index value and presents the obtained analysis result to the user. As a result, appropriate quality evaluation is realized at each stage of the development process.

### Second Example Embodiment

Next, a second example embodiment will be described in detail with reference to drawings.

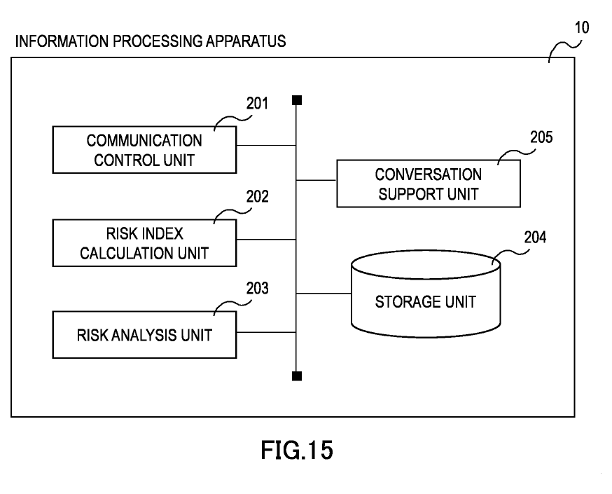

The information processing apparatus 10 according to the second example embodiment differs from the information processing apparatus 10 according to the first example embodiment in that it includes a conversation support unit 205 (see FIG. 15).

The following description will be made with a focus on the difference between the first example embodiment and the second example embodiment.

The conversation support unit 205 acquires either the risk (risk index value) calculated by the risk index calculation unit 202 or the data output by the risk analysis unit 203, and presents it to the user.

Here, the information processing apparatus 10 according to the second example embodiment will be described taking as an example a case where the risk analysis unit 203 determines the necessity of modifying an already completed design based on the risk index value calculated by the risk index calculation unit 202.

In a case where the risk index value acquired from the risk index calculation unit 202 by the risk analysis unit 203 includes a risk index value greater than a predetermined threshold, the risk analysis unit 203 determines that modification (design change) of the design is necessary.

In a case where the risk analysis unit 203 determines that modification of the design is necessary, the conversation support unit 205 issues a warning to the user (such as a designer) and urges a prompt response by the user. Specifically, in a case where the risk index value has increased, the system (the information processing apparatus 10) identifies a plurality of reasons for the increase and provides a user interface that clearly displays the plurality of reasons for the increase.

At the same time, the conversation support unit 205 proposes to the user (for example, the designer) specific measures for reducing the risk proposed by the risk analysis unit 203, and supports the decision-making of the designer.

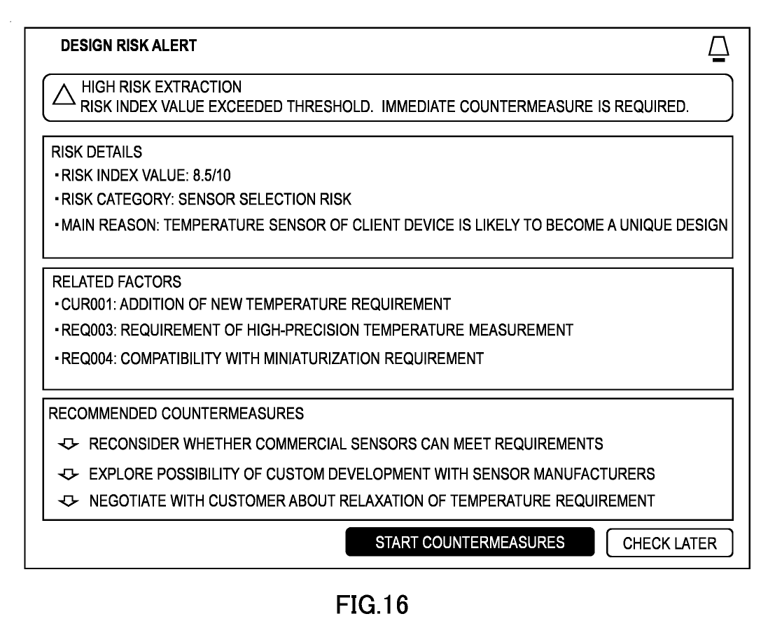

FIG. 16 is a diagram illustrating an example of a screen output to the terminal 20 by the conversation support unit 205. FIG. 16 is a risk alert screen output by the conversation support unit 205.

The risk alert screen is a screen for notifying the designer of high risk that has occurred during the design process and urging prompt action.

For example, at the top of the risk alert screen, a warning bell icon is displayed together with . In addition, immediately below the warning bell icon, an alert banner indicating detection of high risk is displayed.

In the risk details section, the risk index value, the risk category, and the main reasons for the high risk are presented in a bulleted list.

In the related factors section, specific constraints and requirements that affect the risk elements are enumerated.

In the recommended countermeasures section, specific action plans for reducing the risk are presented together with arrow icons.

At the bottom of the risk alert screen, two action buttons, "Start Countermeasure" and "Check Later," are displayed, allowing the designer to choose whether to take immediate action or review the action plan later.

In the risk alert screen, important information is visually emphasized throughout, enabling the designer to quickly understand the risk and take appropriate action.

It should be noted that the risk alert screen shown in FIG. 16 is generated based on the information of risk ID "R001" in FIG. 13 and at least one or more countermeasure proposals calculated for the risk by the risk analysis unit 203.

Here, the conversation support unit 205 may accept questions from the user. In a case where the conversation support unit 205 has accepted a question from the user, the conversation support unit 205 utilizes natural language processing technology to understand the intention of the question and generates an appropriate answer.

In the process of generating the appropriate answer, the conversation support unit 205 refers to detailed information obtained from the risk index calculation unit 202 and the risk analysis unit 203, and provides a specific and accurate explanation in response to the user's question (inquiry).

For example, in a case where the user inquires about the calculation method of the risk index value, the conversation support unit 205 explains the evaluation results and the details of the weighting for each risk element. In addition, in a case where the user inquires about the specific implementation method of a recommended countermeasure or the expected effect, the conversation support unit 205 generates a detailed answer based on past project data and industry best practices.

Furthermore, the conversation support unit 205 may understand the context of the user's question and also provide related additional information to deepen the user's understanding. In addition, the conversation support unit 205 may dynamically generate graphs and charts as necessary and add visual explanations. Through such an interactive conversation process, the designer can gain a deeper understanding of the nature of the risk and obtain sufficient information to take appropriate countermeasures.

It should be noted that the conversation support unit 205 can use a large language model when generating answers to questions. By utilizing a large language model, the conversation support unit 205 can interact with the user in a natural conversational format and be able to respond flexibly even to complex questions.

The model (large language model) used by the conversation support unit 205 has learned expertise related to risk analysis and design processes and may generate answers to the user's questions while taking into account the appropriate context.

As described above, the information processing apparatus 10 according to the second example embodiment provides the results of the risk analysis and the like to the user in an easy-to-understand manner using a user interface. As a result, the user can easily implement necessary design changes or the like.

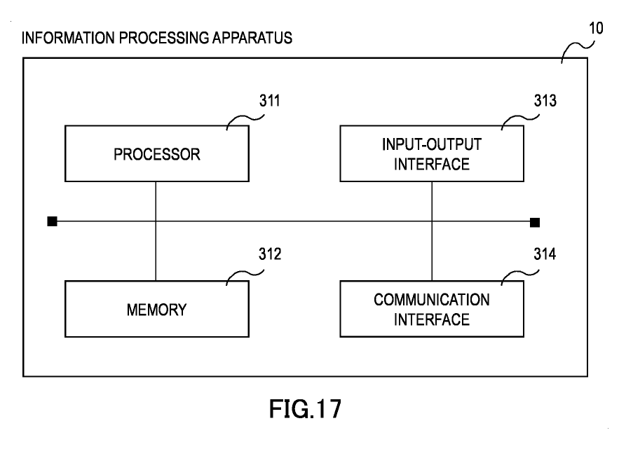

Next, a hardware configuration of an individual apparatus that constitutes the information processing system will be described. FIG. 17 is a diagram illustrating an example of the hardware configuration of the information processing apparatus 10.

The information processing apparatus 10 can be configured by an information processing apparatus (a so-called computer) and has a configuration illustrated as an example in FIG. 17. For example, the information processing apparatus 10 includes a processor 311, a memory 312, an input-output interface 313, a communication interface 314 or the like. The above-described components such as the processor 311 are connected via an internal bus or the like and are configured to be capable of communicating with each other.

However, the configuration shown in FIG. 17 is not intended to limit the hardware configuration of the information processing apparatus 10. The information processing apparatus 10 may include hardware not illustrated, and may not include the input-output interface 313, as necessary. In addition, the number of processors 311 and the like included in the information processing apparatus 10 is not intended to be limited to the example of FIG. 17, and, for example, a plurality of processors 311 may be included in the information processing apparatus 10.

The processor 311 is a programmable device such as a CPU (Central Processing Unit), an MPU (Micro Processing Unit), a DSP (Digital Signal Processor), a TPU (Tensor Processing Unit), a GPU ( Graphics Processing Unit (GPU), or the like. Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read Only Memory), an HDD (Hard Disk Drive), an SSD (Solid State Drive), or the like. The memory 312 stores an OS program, an application program, and various kinds of data.

The input-output interface 313 is an interface for a display apparatus and an input apparatus that are not illustrated. The display apparatus is, for example, a liquid crystal display or the like. For example, the input apparatus is an apparatus that receives user operations, and examples of the input apparatus include a keyboard and a mouse.

The communication interface 314 is a circuit, a module, or the like for performing communication with other apparatuses. For example, the communication interface 314 includes a NIC (Network Interface Card) or the like.

The functions of the information processing apparatus 10 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present disclosure can be embodied as a computer program product. In addition, the above program may be updated by downloading a program via a network or by using a storage medium in which a program is stored. In addition, the above processing modules may be realized by semiconductor chips.

It should be noted that the terminal 20 can also be configured by an information processing apparatus similarly to the information processing apparatus 10, and since its basic hardware configuration is not different from that of the information processing apparatus 10, the description will be omitted.

The information processing apparatus 10 which is an information processing device includes a computer and can realize its functions by causing the computer to execute a program. In addition, the information processing apparatus 10 executes a control method of the information processing apparatus 10 and an information processing method by using this program.

### Variations

It should be noted that the configurations, operations, or the like of the information processing system described in the above example embodiments are examples, and are not intended to limit the configurations or the like of the system.

In the above example embodiments, the case where the information processing apparatus 10 is realized as a server in a server-client system has been described as an example. However, the information processing apparatus 10 may be realized by the terminal 20 of a user in which a predetermined application is installed.

In the above example embodiments, the case where a database is configured inside the information processing apparatus 10 has been described, but the database may be constructed in an external database server or the like. That is, some of the functions of the information processing apparatus 10 may be implemented in another apparatus. More specifically, the "risk analysis unit (risk analysis means)" or the like described above may be implemented in any apparatus included in the system.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present disclosure has been made apparent by the above description. That is, the present disclosure is suitably applicable, for example, to an information processing system that supports system design by a user or the like.

### Supplementary Note 1

An information processing apparatus including:

a risk index calculation means that calculates a risk index value related to at least one or more risk factors accompanying a design result prior to present time by using the design result at least prior to the present time related to a plurality of design tasks constituting a design flow of a system, requirements input in natural language for the design of the system, and constraint conditions; and a risk analysis means that analyzes the risk factors based on the calculated risk index value, and presents an analysis result of the risk factors to a user.

### Supplementary Note 2

The information processing apparatus according to supplementary note 1, wherein the risk index calculation means calculates the risk index value by assuming that a design item that has not yet been used in the design of the system at the present time is used.

### Supplementary Note 3

The information processing apparatus according to supplementary note 1 or 2, wherein the risk analysis means determines whether or not an already completed design needs to be modified based on the calculated risk index value, and further including a communication control means that displays an alert on a terminal of the user, if it is determined that the already completed design needs to be modified.

### Supplementary Note 4

The information processing apparatus according to supplementary note 3, wherein the risk analysis means performs processing, in a case where the risk index value is greater than a predetermined threshold, to identify a reason why at least one or more of the risk index values is greater than the predetermined threshold, and wherein the communication control means displays the identified reason on the terminal of the user.

### Supplementary Note 5

An information processing method including:

The information processing apparatus according to supplementary note 4, wherein the risk analysis means performs processing, in a case where the risk index value is greater than the predetermined threshold, to identify countermeasures for reducing the risk index value that is greater than the predetermined threshold, and wherein the communication control means displays the identified countermeasures on the terminal of the user.

### Supplementary Note 6

calculating a risk index value related to at least one or more risk factors accompanying a design result prior to present time by using the design result at least prior to the present time related to a plurality of design tasks constituting a design flow of a system, requirements input in natural language for the design of the system, and constraint conditions; analyzing the risk factors based on the calculated risk index value; and presenting an analysis result of the risk factors to a user.

### Supplementary Note 7

A program for causing a computer mounted on an information processing apparatus to perform processing for:

calculating a risk index value related to at least one or more risk factors accompanying a design result prior to present time by using the design result at least prior to the present time related to a plurality of design tasks constituting a design flow of a system, requirements input in natural language for the design of the system, and constraint conditions; analyzing the risk factors based on the calculated risk index value; and presenting an analysis result of the risk factors to a user.

In addition, some or all of the configurations described in supplementary note 2 to supplementary note 5, which are dependent on supplementary note 1 as described above, may also be dependent on supplementary note 6 and supplementary note 7 in the same dependency relationship as supplementary note 2 to supplementary note 5. Furthermore, not limited to supplementary note 1, supplementary note 6, and supplementary note 7, within a range not departing from the above-described example embodiments, some or all of the configurations described as supplementary notes may also be made dependent on various hardware, software, various recording means for recording software, or systems.

The entire disclosure of the above patent literature is incorporated herein by reference thereto. While the example embodiments of the present disclosure have thus been described, the present disclosure is not limited to these example embodiments. It is to be understood to those skilled in the art that these example embodiments are only examples and that various variations are possible without departing from the scope and spirit of the present disclosure. That is, the present disclosure of course includes various variations and modifications that could be made by those skilled in the art in accordance with the overall disclosure including the claims and the technical concept.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents. Further, it is noted that the inventor's intent is to retain all equivalents of the claimed disclosure even if the claims are amended during prosecution.

WHAT IS CLAIMED IS:

1. An information processing apparatus comprising:
at least one memory storing a set of instructions; and
at least one processor configured to execute the set of instructions to:
calculate a risk index value related to at least one or more risk factors accompanying a design result prior to present time by using the design result at least prior to the present time related to a plurality of design tasks constituting a design flow of a system, requirements input in natural language for the design of the system, and constraint conditions; and
analyze the risk factors based on the calculated risk index value, and presents an analysis result of the risk factors to a user.

2. The information processing apparatus according to claim 1, wherein
the at least one processor is further configured to execute the set of instructions to calculate the risk index value by assuming that a design item that has not yet been used in the design of the system at the present time is used.

3. The information processing apparatus according to claim 1, wherein
the at least one processor is further configured to execute the set of instructions to:
determine whether or not an already completed design needs to be modified based on the calculated risk index value; and
display an alert on a terminal of the user, if it is determined that the already completed design needs to be modified.

4. The information processing apparatus according to claim 3, wherein
the at least one processor is further configured to execute the set of instructions to:
perform processing, in a case where the risk index value is greater than a predetermined threshold, to identify a reason why at least one or more of the risk index values is greater than the predetermined threshold; and
display the identified reason on the terminal of the user.

5. The information processing apparatus according to claim 4, wherein
the at least one processor is further configured to execute the set of instructions to:
perform processing, in a case where the risk index value is greater than the predetermined threshold, to identify countermeasures for reducing the risk index value that is greater than the predetermined threshold; and
display the identified countermeasures on the terminal of the user.

6. An information processing method comprising:
calculating a risk index value related to at least one or more risk factors accompanying a design result prior to present time by using the design result at least prior to the present time related to a plurality of design tasks constituting a design flow of a system, requirements input in natural language for the design of the system, and constraint conditions;
analyzing the risk factors based on the calculated risk index value; and
presenting an analysis result of the risk factors to a user.

7. The information processing method according to claim 6, further comprising calculating the risk index value by assuming that a design item that has not yet been used in the design of the system at the present time is used.

8. The information processing method according to claim 6, further comprising:
determining whether or not an already completed design needs to be modified based on the calculated risk index value; and
displaying an alert on a terminal of the user, if it is determined that the already completed design needs to be modified.

9. The information processing method according to claim 8, further comprising:
performing processing, in a case where the risk index value is greater than a predetermined threshold, to identify a reason why at least one or more of the risk index values is greater than the predetermined threshold; and
displaying the identified reason on the terminal of the user.

10. The information processing method according to claim 9, further comprising:
performing processing, in a case where the risk index value is greater than the predetermined threshold, to identify countermeasures for reducing the risk index value that is greater than the predetermined threshold; and
displaying the identified countermeasures on the terminal of the user.

11. A non-transitory computer-readable storage medium storing a program causing a computer mounted on an information processing apparatus to perform processing for:
calculating a risk index value related to at least one or more risk factors accompanying a design result prior to present time by using the design result at least prior to the present time related to a plurality of design tasks constituting a design flow of a system, requirements input in natural language for the design of the system, and constraint conditions;
analyzing the risk factors based on the calculated risk index value; and
presenting an analysis result of the risk factors to a user.
